(19) United States
(12) Patent Application Publication
(10) Pub. No.: US 2007/0076018 A1
(43) Pub. Date: Apr. 5, 2007

(54) APPARATUS FOR IMAGE UPSCALING AND THE METHOD THEREOF

(76) Inventor: Chung-Wen Hung, Taichung County (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(21) Appl. No.: 11/309,156

(22) Filed: Jul. 3, 2006

(30) Foreign Application Priority Data
Jul. 4, 2005 (TW) 94122510

(51) Int. Cl. G09G 5/00

(52) U.S. Cl. 345/660

(57) ABSTRACT

An apparatus for image upscaling and the method thereof. The apparatus includes an ADC and a downscaling circuit. The ADC samples and digitizes the signal of an original image at a sampling rate of an integer multiple of the resolution of the original image. The sampled and digitalized result is assembled and output as an oversampled image. The downscaling circuit downscales the oversampled image into a target image by interpolation. The resolution of the oversampled image is greater than or equal to that of the target image, and the resolution of the target image is greater than that of the original image.

### CROSS-REFERENCE TO RELATED APPLICATION

This application claims the priority benefit of Taiwan application serial no. 94122510, filed on Jul. 4, 2005. All disclosure of the Taiwan application is incorporated herein by reference.

### BACKGROUND OF THE INVENTION

1. Field of the Invention

The present invention relates to an apparatus for image upscaling and a method thereof, and more particularly, to an apparatus for image upscaling in which an analog image is converted into a digital image and a method thereof.

2. Description of the Related Art

When it is required to upscale an analog image of fixed resolution by digital signal processing, the conventional technique is to use an analog-to-digital converter (ADC) to sample and digitalize a signal of the analog image, and then the digital image provided by the ADC is upscaled with an interpolation of digital image processing. In such process, the low-bit noise in the ADC, if any, will also be upscaled by the upscaling circuit.

For example, FIG. 1 schematically shows a case where a 5-pixel original image is upscaled to an 8-pixel target image in a conventional technique. The scaling ratio of FIG. 1 is 5/8. Wherein, the first pixel of the target image is located in front of the first pixel of the original image by a distance of 3/16 units (where the unit is a pixel interval of the original image), and the last pixel of the target image (i.e. the 8^{th} pixel) is located behind the last pixel of the original image by a distance of 3/16 units.

FIG. 2 schematically shows an impact of the low-bit noises on the process of FIG. 1. As shown in FIG. 2, if the low-bit noises appear in the pixel 203 (indicated by black stripe in the diagram), when the upscaling circuit uses the 2-pixel interpolation, four pixels of the target image, or the pixels 213˜216, would be affected by the noises. When the upscaling circuit uses the 4-pixel interpolation, six pixels of the target image, or the pixels 222˜227, would be affected by the noises, and the impact range is greater than that of the 2-pixel interpolation.

### SUMMARY OF THE INVENTION

Therefore, it is an object of the present invention to provide an apparatus for image upscaling and a method thereof, which are capable of effectively reducing the low-bit noises of the ADC even when using the same upscaling/downscaling circuit.

In order to achieve the object mentioned above and others, the present invention provides an apparatus for image upscaling, which comprises an ADC and a downscaling circuit. The ADC samples and digitizes a signal of an original image at a sampling rate that is an integer multiple of the resolution of the original image. The sampled and digitalized result is assembled and output as an oversampled image. The downscaling circuit downscales the oversampled image into a target image with an interpolation. Wherein the resolution of the oversampled image is greater than or equal to that of the target image, and the resolution of the target image is greater than that of the original image.

As shown in an embodiment of the present invention, in the present invention, first an original image is digitalized and upscaled into an oversampled image at a sampling rate that is an integer multiple of the resolution of the original image, then the oversampled image is downscaled to a target image with an interpolation. Accordingly, under the condition of using the same upscaling/downscaling circuit, the present invention can effectively reduce the low-bit noises of the ADC.

### BRIEF DESCRIPTION DRAWINGS

The accompanying drawings are included to provide a further understanding of the invention, and are incorporated in and constitute a part of this specification. The drawings illustrate embodiments of the invention, and together with the description, serve to explain the principles of the invention.

FIG. 1 schematically shows a diagram illustrating a conventional method for image upscaling.

FIG. 2 schematically shows an impact of the low-bit noises on the conventional method for image upscaling.

FIG. 3 schematically shows a block diagram of an apparatus for image upscaling according to an embodiment of the present invention.

FIGS. 4˜6 schematically show the impacts of the low-bit noises on the embodiment of the present invention.

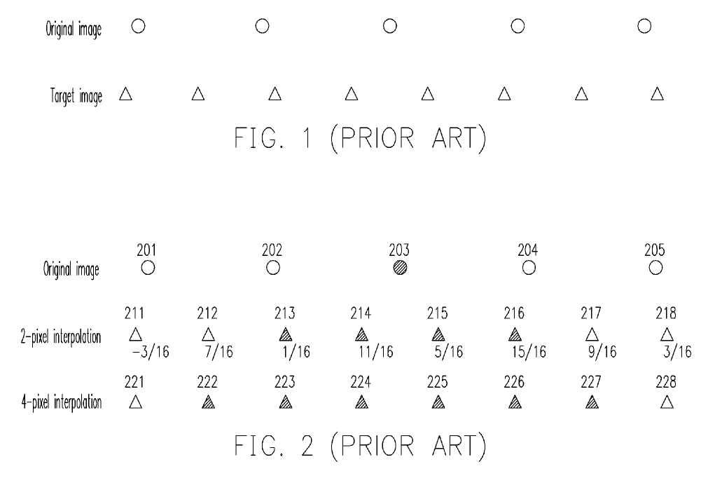

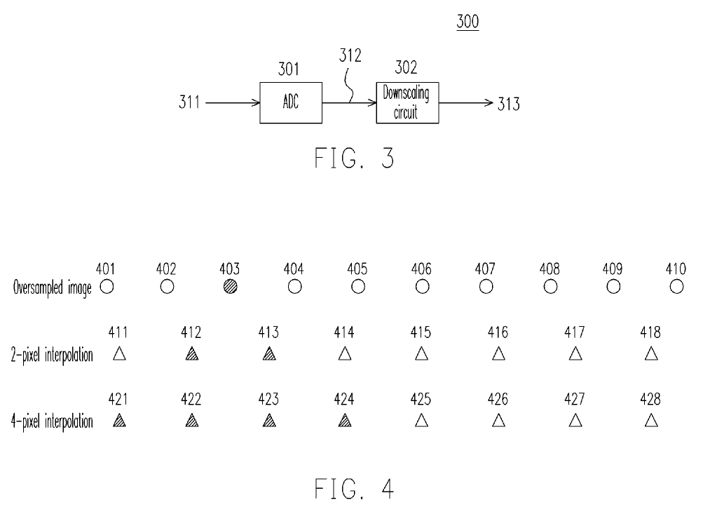

### DESCRIPTION OF THE EMBODIMENTS

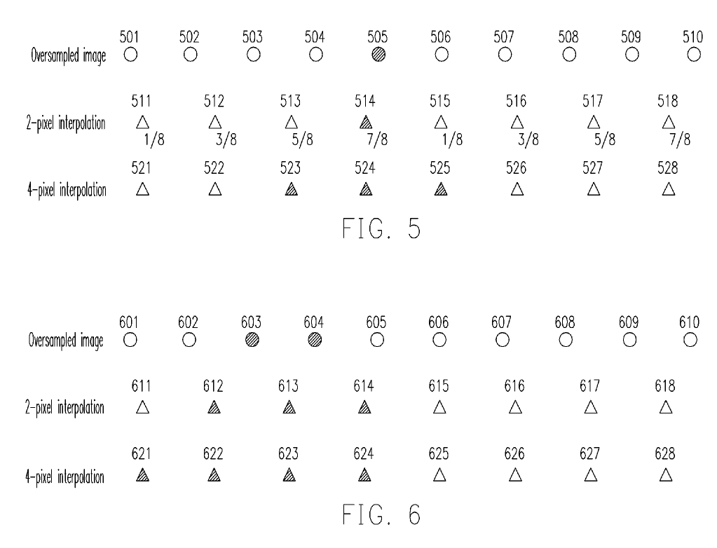

FIG. 3 schematically shows a block diagram of an apparatus for image upscaling 300 according to an embodiment of the present invention. The image upscaling apparatus 300 comprises an ADC 301 and a downscaling circuit 302. Wherein, the ADC 301 receives an original image 311, which is an analog image of fixed resolution. Then, the ADC 301 samples and digitalizes a signal of the original image 311 at a sampling rate that is an integer multiple of the resolution of the original image 311. The sampled and digitalized result is assembled and output as an oversampled image 312 to the downscaling circuit 302. Here, the step of sampling at an integer multiple sampling rate is referred to as oversampling. Accordingly, the resolution of the oversampled image 312 is greater than or equal to that of the original image 311.

Afterwards, a target image 313 is obtained with a downscaling or 1:1 interpolation by the downscaling circuit 302 based on the oversampled image 312. Although the original image 311 had been oversampled and downscaled, the final image is upscaled. In other words, the resolution of the target image 313 is greater than or equal to that of the original image 311.

The embodiments shown in FIG. 4˜6 are referred hereinafter for describing the advantages of the present embodiment. Although the embodiments described below only process a row of pixels in the image, it will be apparent to one of ordinary skill in the art to apply the method of the present invention to the entire image. In the embodiments of FIG. 4˜6, the resolution of the original image is 5 pixels, and the resolution of the oversampled image is two times that of the original one, or 10 pixels, and the resolution of the final target image is 8 pixels.

In the embodiment of FIG. 4, the low-bit noises appear in the pixel 403 of the oversampled image. If the target image is obtained from the 2-pixel interpolation, two pixels, the pixels 412 and 413, will be affected by the noises. If the target image is obtained from the 4-pixel interpolation, four pixels, the pixels 421 to 424, will be affected by the noises. Compared with the conventional technique, the impacts of the 2-pixel interpolation and the 4-pixel interpolation in the conventional technique are 4 pixels and 6 pixels, respectively. Accordingly, the impact of the noises in the present invention is much lower than that of the conventional technique.

If the low-bit noises appear in different locations, the impact may be smaller. For example, in the embodiment of FIG. 5, the noises appear in the pixel 505 of the oversampled image. If the target image is obtained from the 2-pixel interpolation, only one pixel 514 is affected by the noises. This is because the next pixel 515 is located right behind the pixel 506, thus it is not affected by the pixel 505. If the target image is obtained from the 4-pixel interpolation, only three pixels, the pixels 523 to 525, are affected by the noises.

In the embodiments of FIG. 4˜6, the resolution of the oversampled image is two times that of the original one; that is, every pixel in the original image are sampled two times. Both the embodiments of FIG. 4 and FIG. 5 assume that the noises appear in only one sampling. In fact, even the low-bit noises appear in both samplings (the probability is much lower), the impact of the noises in the present invention is still lower than that of the conventional technique. For example, in the embodiment of FIG. 6, the noises appear on both pixels 603 and 604 of the oversampled image. Under the condition of using the 2-pixel interpolation, only three pixels (612 to 614) in the target image are affected by the noises. Under the condition of using the 4-pixel interpolation, only four pixels (621 to 624) in the target image are affected by the noises. Accordingly, the impact due to the noises is significantly reduced when compared with the conventional technique.

In summary, in the present invention, when it is intended to upscale an analog image of fixed resolution, first the original image is oversampled by the ADC, and then the oversampled image is downscaled with an interpolation, such that the impact due to the low-bit noises is reduced.

Although the invention has been described with reference to a particular embodiment thereof, it will be apparent to one of the ordinary skill in the art that modifications to the described embodiment may be made without departing from the spirit of the invention. Accordingly, the scope of the invention will be defined by the attached claims not by the above detailed description.

What is claimed is:

1. An apparatus for image upscaling, comprising:
an analog-to-digital converter (ADC), for sampling and digitizing a signal of an original image at a sampling rate of an integer multiple of a resolution of the original image, and assembling and outputting the sampled and digitalized result as an oversampled image; and
a downscaling circuit, for obtaining a target image with an interpolation based on the oversampled image;
wherein a resolution of the oversampled image is greater than or equal to a resolution of the target image, and the resolution of the target image is greater than the resolution of the original image.

2. The apparatus for image upscaling of claim 1, wherein the sampling rate of the ADC is two times as high as the resolution of the original image.

3. The apparatus for image upscaling of claim 1, wherein the target image is obtained by the downscaling circuit by a 2-pixel interpolation.

4. The apparatus for image upscaling of claim 1, wherein the target image is obtained by the downscaling circuit by a 4-pixel interpolation.

5. The apparatus for image upscaling of claim 1, wherein the original image is an analog image with fixed resolution.

6. A method for image upscaling, comprising:
sampling and digitizing a signal of an original image using an integer multiple of a resolution of the original image as a sampling rate, and assembling and outputting the sampled and digitalized result as an oversampled image; and
obtaining a target image by an interpolation based on the oversampled image;
wherein a resolution of the oversampled image is greater than or equal to a resolution of the target image, and the resolution of the target image is greater than the resolution of the original image.

7. The method for image upscaling of claim 6, wherein the sampling rate is two times as high as the resolution of the original image.

8. The method for image upscaling of claim 6, wherein the target image is obtained by a 2-pixel interpolation.

9. The method for image upscaling of claim 6, wherein the target image is obtained by a 4-pixel interpolation.

10. The method for image upscaling of claim 6, wherein the original image is an analog image with fixed resolution.
